(19) United States
(12) Patent Application Publication
(10) Pub. No.: US 2002/0072983 A1
(43) Pub. Date: Jun. 13, 2002

(54) Virtual product distribution system and method

(76) Inventor: David Teller, Novato, CA (US)

Correspondence Address: DAVID TELLER, 530 Alameda del Prado, Novato, CA, 94949, US

(21) Appl. No.: 09/735,728

(22) Filed: Dec. 12, 2000

(51) Int. Cl. G06F 17/60

(52) U.S. Cl. 705/26

(57) ABSTRACT

A virtual product distribution system and method supports on-line sales from a shopping site where customers place orders for the purchase of products. An independent distributor, who is local to the customer and maintains an inventory or the retailer's products, is informed of the order when it is placed. The local distributor receives instructions from the retailer on the contents of the order and location of delivery, so the distributor may provide the customer with as many products from the order as are in the local distributor's inventory. The customer receives a receipt code from the retailer. When the local distributor delivers the products to the ordering customer, the customer provides the local distributor wash the receipt code, which the local distributor returns to the retailer as proof of delivery. The retailer then compensates the local distributor for the delivery of products.

### BACKGROUND OF THE INVENTION

1. Field of the Invention

This invention relates to product distribution systems and, more particularly, to computer network product and delivery systems.

2. Description of the Related Art

Retail businesses must keep careful control over product orders, sales, and deliveries. Many retail businesses are involved in direct marketing customer sales, such as mail order and phone order purchases. Customers typically comprise individuals, who may peruse catalogs from the convenience of their homes and then fill out an order form, which they send to the retailer. The retailer receives the order and processes it for delivery. Typically, a received order is sent to a warehouse facility, which can employ many hundreds of people and requires the coordination of receiving, packing, and transportation personnel. The products ordered by the customer are assembled and boxed for shipment from the warehouse. A packing slip is inserted in the shipment box, to confirm the contents of the order and inform the customer of any separately shipped items, such as where an inventory shortage has occurred. The boxed products are then shipped to the customer. At each step of the transaction, there are potentially multiple paper forms to process, adding to overhead.

More recently, much retail business has moved on-line, via the Internet and other computer networks. Products can be reviewed on-line through a web browser, and orders can be placed through Internet messaging, such as e-mail messages and the like. This reduces some of the overhead costs that retail businesses would otherwise incur. For example, fewer catalogs need be printed, and order forms need not be routed through mail rooms and across order desks. Most products, however, are still processed through a central warehouse facility, where the products are collected, boxed, and shipped to customers. Thus, on-line business, or e-commerce, has reduced somewhat the cost of doing business, but most all of the associated warehouse and delivery personnel previously required are still needed, with the concomitant costs incurred by supporting the order processing facilities, packing slips, and transportation personnel.

From the discussion above, it should be apparent that there is a need for an efficient product distribution system and process that reduces overhead costs while permitting receipt of customer orders with prompt, accurate, and complete delivery of the orders. The present invention fulfills this need.

### SUMMARY OF THE INVENTION

The invention provides a product distribution system and method in which an on-line retailer produces a shopping site accessible to a computer network customer, who places an order for the purchase of products. An independent distributor, who is geographically local to the customer and maintains an inventory of the retailer's products, is informed of the order when it is placed and is instructed to provide the customer with as many products from the order as are in the local distributor's inventory. The retailer also provides the customer with a receipt code. When the local distributor delivers the products to the ordering customer, the customer provides the local distributor with the receipt code, which the local distributor returns to the retailer as proof of product delivery. The retailer then compensates the local distributor for the delivery of the products. The independent distributors maintain their own inventory of products, from which deliveries occur. The distributors are local to the customer, where the geographic distance to the customer is such that product delivery times are reduced, preferably to less than one day. In this way, the retailer utilizes a network of independent distributors to deliver products purchased by customers. This creates a “virtual warehouse” system, such that the retailer reduces the overhead of maintaining a retailer warehouse distribution system and employees, capital equipment, and other associated expenses.

The virtual warehouse system provided by the invention can result in a relatively paperless transaction in which the customer's order, the local distributor's delivery instructions, the confirmation of the receipt code, and the payment to the local distributor, can all be accomplished through computer network communications with appropriate database records, without printing and sending of paper documents. This reduces overhead and decreases the time from order to receipt of product, thereby making the transaction more efficient. The system functions efficiently in conjunction with a database that stores the distributor identification and location information.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram representation of a virtual warehouse distribution system constructed in accordance with the present invention.

FIG. 2 is a block diagram representation of a computer system that supports the veal warehouse distribution system illustrated in FIG. 1.

FIG. 3 is a flow diagram that illustrates the business method of implementing the virtual warehousing distribution system of FIG. 1.

FIG. 4 is a representation of a GUI customer delivery specification screen as shown on the display device of the FIG. 2 computer, in accordance with the present invention, for specifying mode of product delivery.

FIG. 5 is a representation of a GUI local distributor bid screen as shown on the display device of the FIG. 2 computer, in accordance with the present invention, for entering a bid for product delivery.

FIG. 6 is a representation of a GUI local distributor delivery screen as shown on the display device of the FIG. 2 computer, in accordance with the present invention, for entering the receipt code received from a customer for delivery payment.

### DESCRIPTION OF THE PREFERRED EMBODIMENT

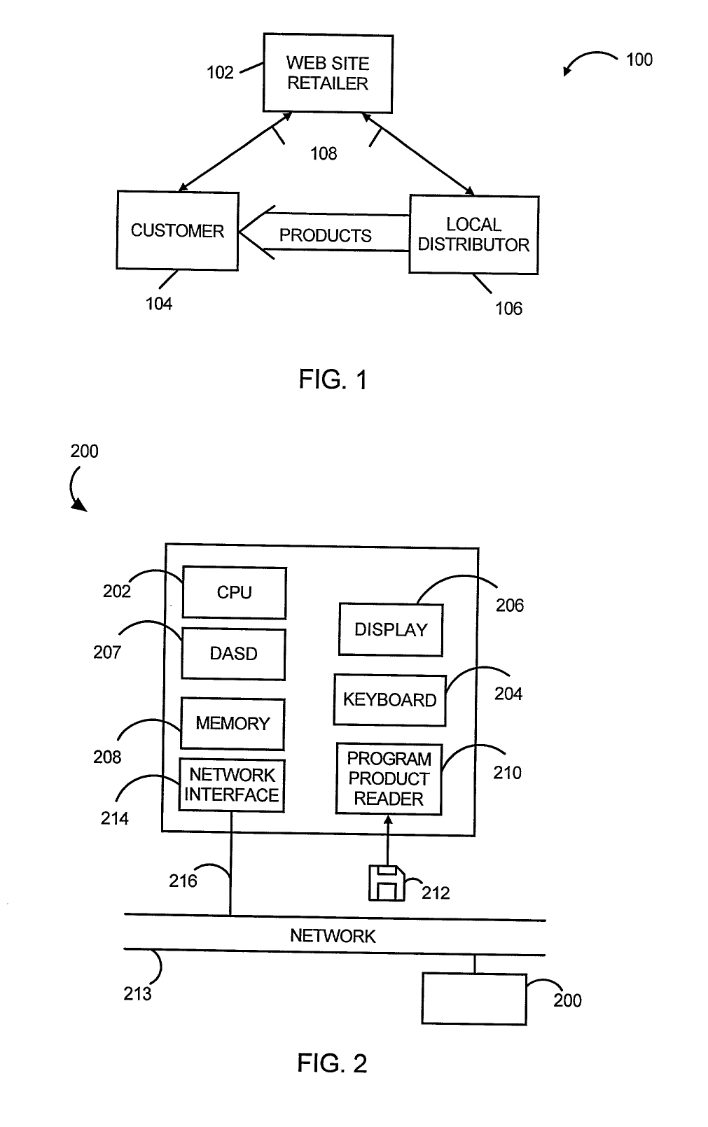

FIG. 1 shows a distribution system 100 constructed in accordance with the present invention, in which a retailer computer network site 102 is visited by on-line customers 104 who place orders for the purchase of goods from the retailer for delivery by a local, independent distributor 106. The system functions in conjunction with the purchase and delivery of various goods that the local distributor can purchase in advance and keep on hand for deliveries. Alternatively, the local distributor may not actually buy the product until after the on-line customer makes a purchase. For example, the system 100 may be used by an on-line book seller, so that each local distributor may easily maintain on-hand a relatively compact inventory of best-selling books. When the customer places an order, the retailer sends back a receipt code and then relays the customer purchase information to the local distributor 106, who is located in a geographic area nearby to the customer 104 such that the distributor may physically transport and carry the ordered products to the customer. When the local distributor delivers the products, the customer provides the local distributor with the receipt code, which the distributor returns to the retailer as proof of delivery. The retailer then compensates the local distributor for the products and for their delivery. This permits the retailer to utilize a network of independent local distributors to deliver products purchased by customers and provides a “virtual warehouse” system for carrying on the product delivery business of the retailer. No papers need exchange hands from customer to retailer to distributor, from order placement through customer receipt of the actual delivered product. The advantage to the retailer is the elimination of overhead for maintaining a product distribution system, employees, capital equipment, and other associated overhead expenses.

Communications between the retailer 102, customer 104, and local distributor 106 preferably take place over a widely available computer network 108, such as the well-known Internet. In the preferred embodiment, a physical delivery of products is the only contact that will occur between a customer and a local distributor. Thus, preferably no direct communication between the customer and local distributor over the computer network 108 is necessary to fill the order. More particularly, the FIG. 1 system 100 is comprised of computers 102, 104, 106 located at network nodes. Thus, the retailer 102 comprises a node of the network 108, each customer 104 comprises a computer at another node, and each local distributor comprises a computer at another node of the network 108. Those skilled in the art will understand that the computers 102, 104, 106 can all have a similar construction.

FIG. 2 is a block diagram of an exemplary computer 200 such as might comprise any of the computers 102, 104, 106. Each computer 200 operates under control of a central processor unit (CPU 202, such as a “Pentium” microprocessor and associated integrated circuit chips, available from Intel Corporation of Santa Clara, Calif., USA. A computer user can input commands and data from a keyboard 204 and can view inputs and computer output at a display 206. The display is typically a video monitor or flat panel display. The computer 20 also includes a direct access storage device (DASD) 207, such as a hard disk drive. Computer memory 208 typically comprises volatile semiconductor random access memory (RAM). Each computer preferably includes a program product reader 210 that accepts a program product storage device 212, from which the program product reader can read data (and to which it can optionally write data). The program product reader can comprise, for example, a disk drive, and the program product storage device can comprise removable storage media such as a magnetic floppy disk, an optical CD-ROM disc, or a magneto-optical CD-RW, CD-R, or DVD-RW disc. Each computer 200 communicates with the others over the network 108 through a network interface 214 that enables communication over a connection 216 between the network and the computer.

The CPU 202 operates under control of programming steps that are temporarily stored in the memory 208 of the computer 200. When the programming steps are executed, the respective computers carry out process steps to implement the appropriate functionality, as described further below. The programming steps can be received from the DASD 207, through the program product storage device 212, or through the network connection 216. The storage drive 210 can receive a program product 212, read programming steps recorded thereon, and transfer the programming steps into the memory 208 for execution. As noted above, the program product storage device can comprise any one of multiple removable media having computer-readable instructions, including floppy disks and CD storage. Other suitable program product storage devices can include magnetic tape and semiconductor memory. In this way, the processing steps necessary for operation in accordance with the invention can be embodied on a program product. Alternatively, the program steps can be received into the operating memory 208 over the network 108. In the latter method, the computer receives data into the memory 208 thorough the network interface 214 after network communication has been established over the network connection 216 by well-known methods that will be understood by those skilled in the art without further explanation.

It should be understood that all of the computers 102, 104, 106 of the computer system illustrated in FIG. 1 have a construction similar to that shown in FIG. 2, so that details described above with respect to the FIG. 2 computer 200 will be understood to apply to all computers of the system 100. Alternatively, any of the computers 102, 104, 106 can have a different construction, so long as they can communicate with the other computers and support the functionality described herein.

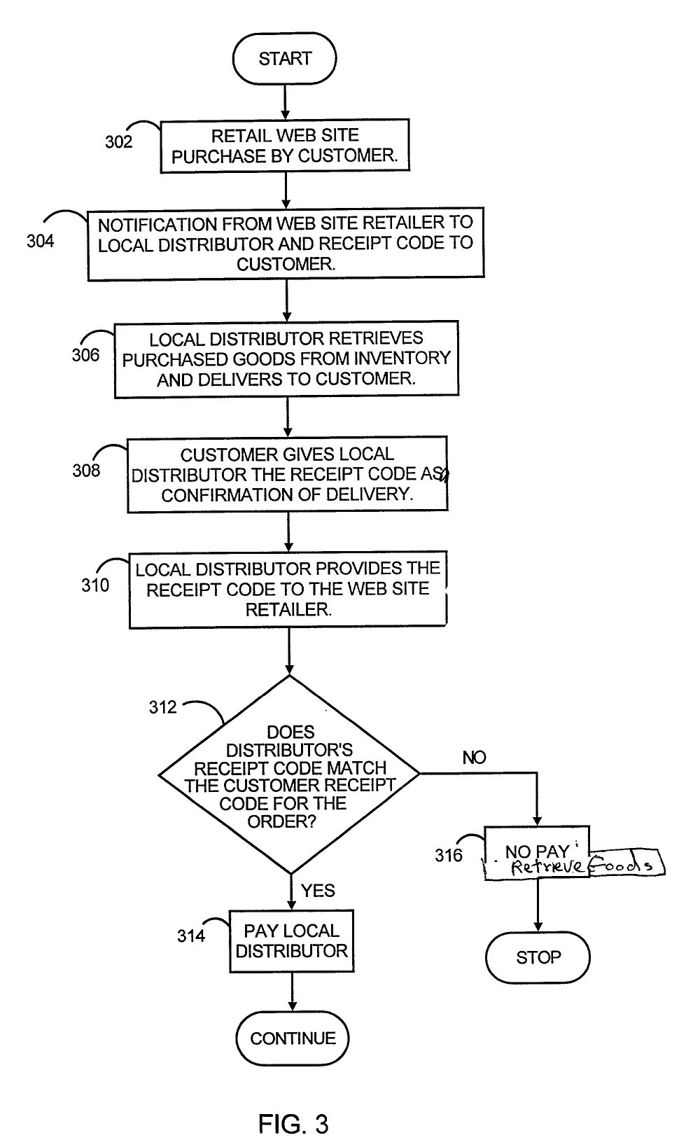

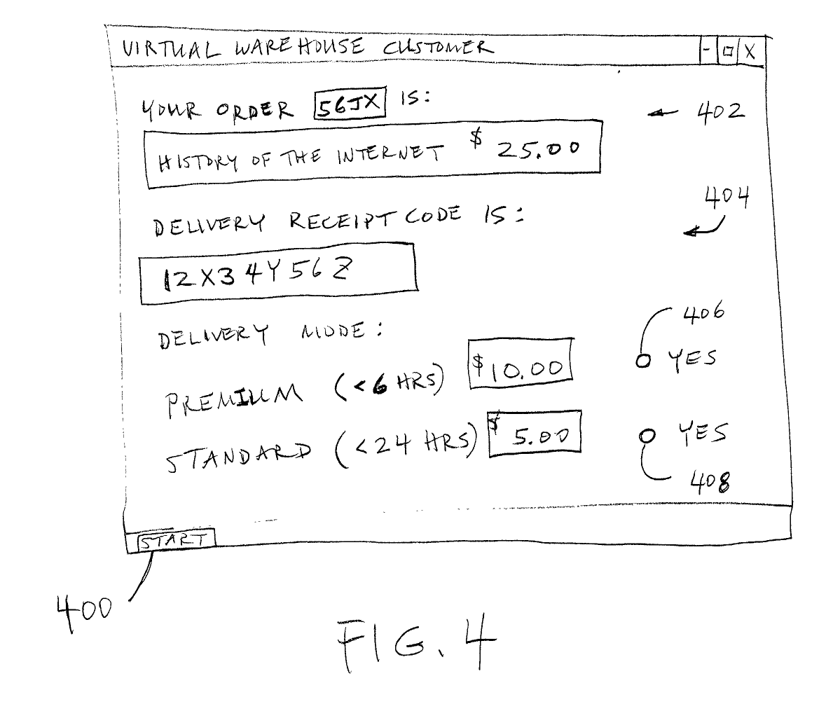

FIG. 3 is a flow diagram that illustrates the method of implementing the virtual warehousing distribution system of FIG. 1. FIG. 3 shows that the first step in implementing the system occurs when the retailer computer receives an on-line sales order from a customer. This first step is represented by the flow diagram box numbered 302. The sales order preferably occurs during an interactive on-line purchase session that is secure so as to keep billing and order information confidential. Next, at the box numbered 304, the web site retailer sends a notification of the order from the retailer computer to the computer of an appropriate local distributor. A receipt code is generated for the order and must be provided to the customer. Different schemes may be used to select an appropriate local distributor, as described more fully below.

To properly deliver the order notifications from customers and to provide customer delivery instructions to the appropriate local distributors, the on-line retailer must retailer a database of local distributor contact information, and must have access to geographical information for distributors and customers, as well as collect the delivery information from each customer. The retailer must also maintain the database with the delivery information and generate the information for delivery. The geographical information my comprise, for example, U.S. “zip code” postal information. The database can be maintained in data storage of the retailer computer or in another data storage facility with which the retailer computer can communicate over the network.

The database of local distributor contact information lists the independent local distributors whom the retailer may call upon for deliveries. With such a database, the retailer can easily determine the local distributor who is closest to the customer for delivering a given product order to a particular customer, such as by comparing postal codes for the address of the customer with postal codes for the local distributors to locate the closest distributor. If desired, the retailer can contact local distributors in order of proximity to the ordering customer, requesting order fulfillment, and placing the order with the first local distributor who agrees to fill the order. Other schemes to select a local distributor may be used. For example, the retailer may elect to conduct a bidding competition between competing distributors for the order, so that the first local distributor to respond to a request within a predetermined interval will be given the order to fill. Alternatively, the selection may comprise selecting the highest bid for order fulfillment that is received within the time interval. Any bids received outside the bidding time interval will not be considered.

In another scheme for electing a local distributor, the retailer computer may estimate a time to delivery for multiple local distributors based on location information. The local distributors may agree to predetermined levels of service (delivery time) for different scales of payment. Thus, selection of local distributors may be based on time to delivery and service level incentives. Customers may agree to pay different amounts for delivery, depending on the response timeliness selected, distance from nearest local distributor, or a combination. With the alternative delivery schemes described above, it is anticipated that actual delivery may take place in a matter of hours following order placement.

In all of these situations, the retailer may require that local distributors who wish to be considered for order fulfillment must first provide a security deposit with the retailer. The security deposit would be kept in an account and would be withdrawn in the event that the depositing local distributor fails to make a timely delivery or otherwise fails to make appropriate delivery. This is especially important for those systems in which the retailer conducts bidding for order fulfillment, as there should be some assurance that a successfully bidding local distributor who ultimately fails to make timely delivery does not displace a losing distributor who would have successfully delivered the order. In this way, the security deposit acts as a “damages” accounting between retailer and local distributor.

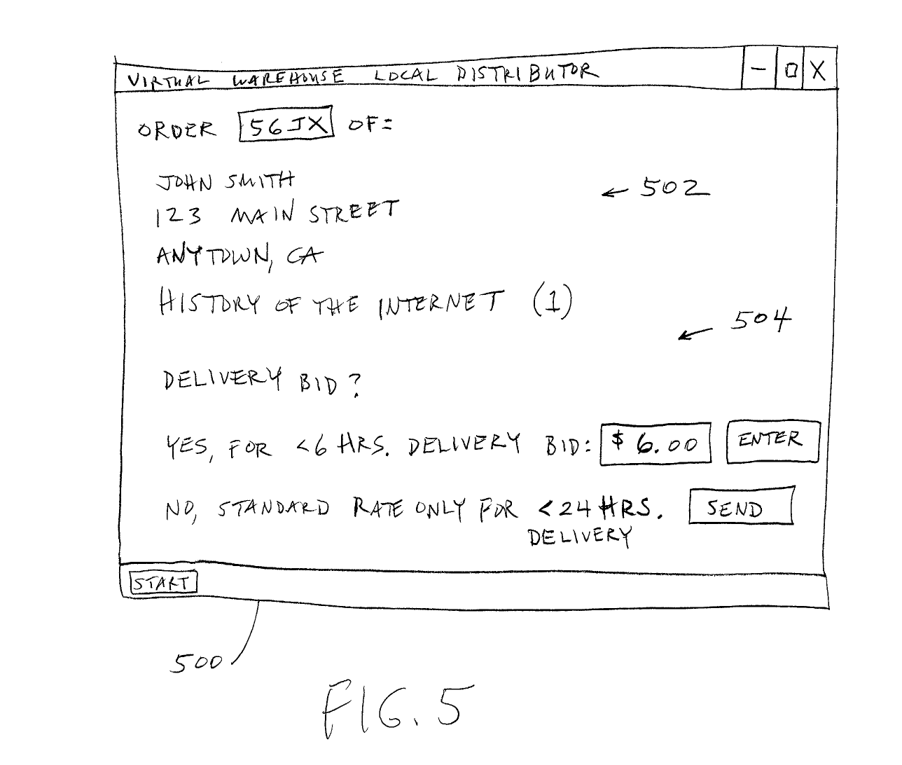

In the preferred embodiment, a customer may make a selection of delivery mode, and price, using a graphical user interface (GUI) program (such as an Internet browser program) that shows a delivery menu on the user computer display. FIG. 4 is a representation of a GUI customer delivery specification screen 400 as shown on the display device of the FIG. 6 computer, in accordance with the present invention, for the customer to specify the mode of product delivery.

The window 400 of FIG. 4 shows that a user is provided confirmation of the order 402, identification of the confirmation code 404, and then may select from a “Premium” delivery mode and a “Standard” delivery mode. Either of these two modes can be selected by moving the user display mouse or other display control to position a cursor over the appropriate delivery mode selection button 406, 408. Each mode provides a different level of service (promptness) and each mode is associated with a different price. The retailer may respond to selection of the first level (Premium), for example, by opening the delivery contract to a bidding among multiple local distributors who are located within a geographic area near the customer. The winning bidder then receives the order information and delivers the product. The retailer may respond to selection of the second level (Standard) by sending a delivery request only to the closest located local distributor in the customer's geographic area.

Those skilled in the art will appreciate that the information shown in FIG. 4 may be communicated to the customer through an Internet e-mail program, web browser program, or other suitable computer network communications means. For example, the display 400 may comprise an Internet web site display that customers view upon visiting the retailer's web site and placing an order.

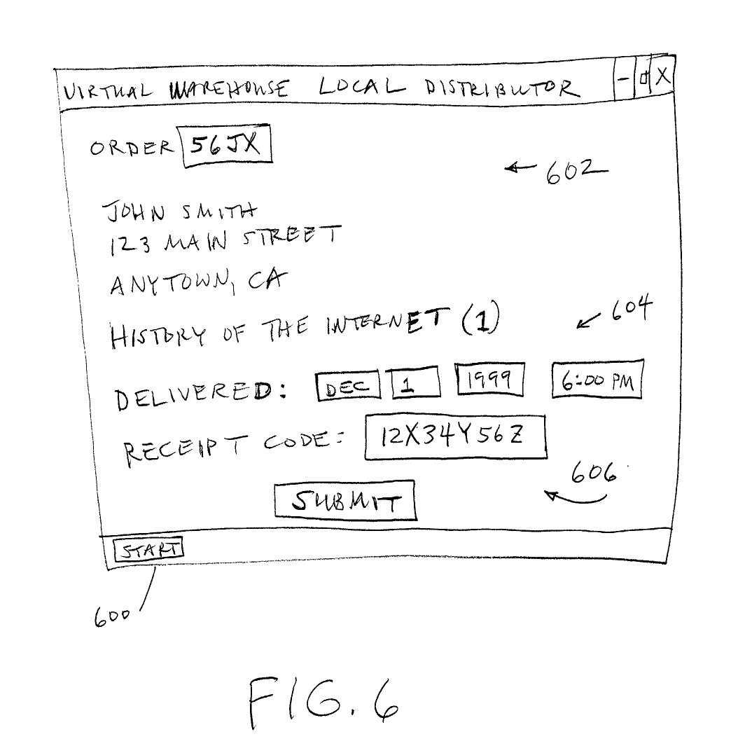

As noted above, when the local distributors receive notification of an order, they may receive an invitation to bid on an order. They should be given the location of product delivery and the products to be delivered, so as to assess whether they are located sufficiently close to the customer, and have the correct inventory, to make bidding worthwhile. FIG. 5 is a representation of a GUI local distributor bid screen as shown on the display device of the FIG. 6 computer, in accordance with the present invention, for the local distributor to enter a bid for product delivery.

The window 500 of FIG. 5 shows that a local distributor may view a web site, at which the local distributor may elect to bid on the delivery. The bid will preferably include a bid or contract price, for which the local distributor will agree to deliver the product. That is, the local distributor display will include an area 502 with order details and a bid area 504 in which the local distributor can select and enter a response. The local distributor's selection is automatically sent to the retailer computer, such as through conventional Internet mail servers, whereupon the retailer makes a selection and notifies the appropriate local distributor. If no bidding responses are received, the retailer may downgrade the order to a “standard” default level and notify the appropriate local distributor of the delivery for a standard contract rate, or may make arrangements for alternative delivery schemes. In this way, the retailer can select from multiple delivery schemes without requirement for sending paper notification or verifying with paper notification, and without maintaining “brick and mortar” warehouse facilities.

Those skilled in the art will appreciate that the information shown in FIG. 5 may be communicated to the customer through an Internet e-mail program, web browser program, or other suitable computer network communications means. For example, the display 500 may comprise an Internet web site display that local distributors view upon visiting the retailer's web site and logging in, or upon launching an e-mail program from their computer.

Further with respect to the flowchart of FIG. 3, the order notification to the local distributor comprises a list of products ordered and the customer address, with a request for delivery. In the preferred embodiment, the order notification is sent to the local distributor at approximately the same time as the receipt code is sent to the customer. As described more fully below, the receipt code will be given to the local distributor as confirmation of delivery. The communication of the customer order to the retailer, the notification to the local distributor, and the receipt code to the customer may all be communicated over the network using one of various acceptable communication protocols, such as HTTP, SMTP, or FTP, through e-mail or web browser communication facilities or cell phone, if distributor prefers to confirm, at the customer's premise, that the receipt code given to him by the customer is correct. All such processing is represented by the FIG. 3 flow diagram box numbered 304.

In the next step of processing, represented diagram box numbered 306, the independent local distributor retrieves the customer-purchased goods from the distributor inventory and delivers the goods to the customer. Each local distributor will be independent, meaning that the distributor will be an independent contractor, franchisee, or licensee of the on-line retailer, such that the local distributor will purchase goods from the retailer and will maintain an inventory of goods in advance of receiving orders and delivery instructions. This on-hand inventory minimizes the amount of time between order placement and order delivery. This also reduces the likelihood that the distributor will not have all of the ordered products in local inventory. In the case of a book selling system, for example, the local distributor may maintain an inventory of the twenty best-selling books or some other selection of popular titles that are more likely to be the object of purchase orders.

The independent local distributor quickly delivers the products ordered by the customer, in accordance with the order notification and delivery instructions received from the retailer. When the local distributor makes the delivery, the customer gives the local distributor the receipt code as confirmation of the physical receipt of products. Such information is maintained in the retailer database. In the virtual warehouse system of the invention, it is preferred that such records not be entered on paper records, but be maintained only in a database of the retailer. The step of product delivery and receipt code communication is represented by the FIG. 3 flow diagram box numbered 308.

After the local distributor delivers the product and the customer gives the receipt code to the distributor, the local distributor must communicate the fact of successful delivery to the retailer and must provide the receipt code back to the retailer to receive payment. This step is represented by the flow diagram box numbered 310. Upon receiving the proper receipt code, which the retailer can match up and verify against the original order records, the retailer will provide compensation to the local distributor. The verification step is indicated by the decision box numbered 312, which indicates that upon receiving a message from the independent local distributor, the retailer computer compares the receipt code submitted by the local distributor against the receipt code that was sent to the customer.

The local distributor will preferably communicate the receipt code to the retailer through a computer network communication, preferably through a GUI program. FIG. 6 is a representation of a GUI local distributor delivery screen 600 as shown on the display device of the FIG. 2 computer, in accordance with the present invention, for entering the receipt code received from a customer so the local distributor can submit it to the retailer and receive payment for the delivery. The delivery screen preferably includes an order identification area 602 and a delivery details area 604 in which to enter order details. The receipt code is entered and submitted in a data entry area 606, and the information is automatically sent to the retailer computer by computer network delivery means, such as e-mail (SMTP or HTTP transfer

Those skilled in the art will appreciate that the information shown in FIG. 6 may be communicated to the customer through an Internet e-mail program, web browser program, or other suitable computer network communications means. For example, the display 600 may comprise an Internet web site display that local distributors view upon visiting the retailer's web site and logging in, or upon launching an e-mail program from their computer.

Returning to the FIG. 3 flow diagram, if the submitted receipt code matches the set receipt code, an affirmative outcome at the decision box, then at the flow diagram box numbered 314 the retailer computer causes the local distributor to be paid for the products and for the delivery. The amount of such compensation should take into account the physical act of delivery itself and the original purchase of products, as transacted between the retailer and the local distributor. Other processing of the system may then continue. If the distributor receipt code does not match the customer receipt code, a negative outcome at the decision box 312, then at box 316 the retailer computer denies payment and payment processing is halted.

Other variations from the local distributor selection described above may be used. For example, access to a database of the inventory kept at local distributors may be provided to on-line retailers. When an on-line retailer makes a sale, the retailer may either provide its own delivery arrangements, or the retailer may use the local distributor to make the delivery, using one of the techniques descried above. Thus, the local distributors may operate independently of the retailers, and may work with more than one retailer. Another technique may be to implement a delivery scheme where distributors may receive bulk shipments of product from retailers intended for multiple customers. The local distributors would break down the shipments and deliver the products to the individual customers. Thus, if books are involved, a retailer may ship twenty copies of the same book to a local distributor, with the names and addresses of twenty customers. The local distributor then delivers the products accordingly. In conjunction with the features described above, this scheme could significantly reduce shipping costs for the retailers and, consequently, for the customers.

As described above, the present invention provides a virtual product distribution system that supports on-line sales from a website where customers place orders for products of a retailer and an independent local distributor maintains an inventory of at least some of the retailer's products. The local distributor is informed of the order when it is placed and receives instructions for the product order and location of delivery, so the distributor may provide the customer with as many products from the order as are in the local distributor's inventory. When the local distributor delivers the products to the ordering customer, the customer provides the local distributor with a receipt code, which the local distributor returns to the retailer as proof of delivery. The retailer then compensates the local distributor for the delivery of products. All such order processing steps can be performed without paper forms exchanging hands between the participants. Moreover, the size of any warehouse needed by the retailer is reduced.

The present invention has been described above in terms of a presently preferred embodiment so that an understanding of the present invention can be conveyed. There are, however, many configurations for product distribution systems not specifically described herein but with which the present invention is applicable. The present invention should therefore not be seen as limited to the particular embodiments described herein, but rather, it should be understood that the present invention has a wide applicability with respect to product distribution systems generally. All modifications, variations, or equivalent arrangements and implementations that are within the scope of the attached claims should therefore be considered within the scope of the invention.

I claim:

1. A method of paperless product distribution comprising:
supporting an interactive computer network purchase session in which a remote customer places a product order with a retailer for purchase of one or more products and for delivery to the customer;
providing details of the product order to an independent local distributor, who is geographically local to the customer, and providing a receipt code from the retailer in a return computer network message to the customer;
initiating delivery of at least one of the ordered products from the independent local distributor to the customer; and
receiving delivery confirmation, comprising return of the receipt code at the retailer from the independent local distributor, and making payment from the retailer to the independent local distributor.

2. A method as defined in clam 1, wherein supporting an interactive computer network purchase session comprises maintaining an Internet web site through which the customer can place orders and make payment to the retailer.

3. A method as defined in claim 1, wherein providing details of the product order comprises sending a computer network message from the retailer to the independent local distributor, listing the products ordered and the customer who ordered them.

4. A method as defined in claim 1, wherein initiating delivery comprises a request from the retailer to the independent local distributor for delivery of at least one of the ordered products to the customer.

5. A method as defined in claim 1, wherein receiving delivery confirmation comprises receipt by the retailer of a computer network message containing the receipt code provided by the retailer to the customer.

6. A method as defined in claim 1, wherein initiating delivery comprises communicating a bid for contracting delivery from one of a plurality of local distributors to the retailer.

7. A method as defined in claim 6, wherein the local distributor's delivery bid includes an election of delivery level of service.

8. A method as defined in claim 6, wherein the retailer requests only one local distributor to deliver the ordered product.

9. A method of paperless product distribution comprising:
receiving a product order at a retailer computer site from a remote customer, the product order comprising a communication message sent over an interactive computer network system from the customer to the retailer, in which the customer specifies one or more retailer products for purchase and delivery;
sending details of the product order from the retailer computer site to an independent local distributor, who is local to the customer, and sending a receipt code in a communication message over the computer network system from the retailer computer site to the customer; and
receiving delivery confirmation at the retailer computer site, wherein the delivery confirmation comprises return of the receipt code sent to the customer in a communication message that is received from the independent local distributor and, in response, making payment from the retailer to the independent local distributor.

10. A method as defined in claim 9, wherein the interactive computer network system over which the communication message is sent comprises the Internet.

11. A method as defined in claim 9, wherein sending details of the product order comprises sending a computer network message to the independent local distributor, listing the products ordered and identifying the customer who ordered them, and requesting a bid from one or more local distributors for contracting delivery of the product order.

12. A method as defined in claim 9, wherein initiating delivery comprises communicating a bid for contracting delivery from one of a plurality of local distributors to the retailer.

13. A method as defined in claim 12, wherein the local distributor's delivery bid includes an election of delivery level of service.

14. A method as defined in claim 12, wherein the retailer requests only one local distributor to deliver the ordered product.

15. A computer system for a paperless product delivery system, the computer system comprising:
a retailer computer at a retailer business site; and
a network communications interface between an interactive computer network system and the retailer computer;
wherein the retailer computer (1) receives a product order from a remote customer, the product order comprising a communication message sent over the interactive computer network system from the customer through the communication interface and to the retailer business site, in which the customer specifies on or more retailer products for purchase and delivery, (2) sends details of the product order from the retailer computer to an independent local distributor, who is geographically local to the customer, and sends a receipt code in a communication message over the computer network system from the retailer computer through the communications interface to the customer, and (3) receives delivery confirmation, wherein the delivery confirmation comprises return of the receipt code sent to the customer in a message that is received from the independent local distributor and, in response, the retailer initiates payment to the independent distributor.

16. A computer system as defined in claim 15, wherein the interactive computer network system over which the communication message is sent comprises the Internet.

17. A computer system as defined in claim 15, wherein the details of the product order comprise an e-mail message sent over the Internet to the independent local distributor, listing the products ordered and identifying the customer who ordered them

18. A computer system as defined in claim 1, wherein the delivery confirmation comprises a computer network message received at the retailer computer, the message containing a receipt code, and the receipt code of the message is verified as being identical to the receipt code provided by the retailer computer to the customer.

19. A computer system as defined in claim 15, wherein the retailer computer sends details of the product order by sending a computer network message to the independent local distributor, listing the products ordered and identifying the customer who ordered them, and requesting a bid from one or more local distributors for contracting delivery of the product order.

20. A computer system as defined in claim 19, wherein the retailer computer initiates delivery after receiving a bid for contracting delivery from one of a plurality of local distributors.

21. A computer system as defined in claim 19, wherein the received local distributor's delivery bid includes an election of delivery level of service.

22. A computer system as defined in claim 19, wherein the retailer requests only one local distributor to deliver the ordered product.

23. A computer system for a paperless product delivery system, the computer system comprising:
a customer computer at a customer location; and
a network communications interface between an interactive computer network system and the customer computer;
wherein the customer computer (1) sends a product order to a business retailer computer at a remote location, the product order comprising a communication message sent over the interactive computer network system from the customer through the communications interface and to the business retailer computers in which the customer specifies one or more retailer products for purchase and delivery, and (2) receives a receipt code in a communication message from the business retailer computer over the computer network system through the communications interface, thereby confirming to the customer that the business retailer computer has sent details of the product order to an independent local distributor, who is local to the customer, such that the customer can provide the receipt code to the independent local distributor upon product delivery to the customer, and the receipt code can be verified by the business retailer computer as being the identical receipt code sent to the customer, such that the business retailer computer can initiate payment processing to the independent local distributor.

24. A computer system as defined in claim 23, wherein the interactive computer network system over which the communication message is sent comprises the Internet.

25. A computer system as defined in claim 23, wherein the details of the product order comprise a computer network message sent over the Internet to the independent local distributor, listing the products ordered and identifying the customer who ordered them.

26. A computer system as defined in claim 23, wherein the delivery confirmation comprises a computer network message received at the retailer computer, the message containing a receipt code, and the receipt code of the message is verified as being identical to the receipt code provided by the retailer computer to the customer.

27. A computer system as defined in claim 23, wherein the customer computer specifies an election of delivery level of service or the customer product order.

28. A database stored in data storage of a retailer database computer, the database comprising:
a plurality of product orders each of which comprises an order from a customer to the retailer for purchase of one or more products to be delivered to the customer by an independent local distributor; and
a plurality of data records, each of which is linked to a product order of; each data record containing independent local distributor information that relates to the product order and identifies an independent local distributor who is geographically local to the customer, and is associated with a receipt code that is provided to the customer over an interactive computer network system and then is returned to the retailer by the local distributor such that the provided receipt code for the product order can be retrieved from the database and compared to the sent receipt code, such that a match indicates that the local distributor received the receipt code from the customer upon deliver of the ordered products and is warranted payment for delivery.

29. A database as defined in claim 28, wherein the interactive computer network system over which the communication message is sent comprises the Internet.

30. A database as defined in claim 28, wherein the details of the product order comprise a computer network message sent over the Internet to the independent local distributor, listing the products ordered and identifying the customer who ordered them.

31. A database as defined in claim 28, wherein the delivery confirmation comprises a computer network message received at the retailer computer, the message containing a receipt code, and the receipt code of the message is verified as being identical to the receipt code provided by the retailer computer to the customer.

32. A database as defined in claim 28, wherein the product order information includes a specification of delivery level of service for the customer product order.
